(19) United States
(12) Patent Application Publication
(10) Pub. No.: US 2014/0278475 A1
(43) Pub. Date: Sep. 18, 2014

(54) Tele-analytics based treatment recommendations

(71) Applicant: Bao Tran, Saratoga, C (US)

(72) Inventor: Bao Tran, Saratoga, C (US)

(21) Appl. No.: 13/843,903

(22) Filed: Mar. 15, 2013

(51) Int. Cl. G06F 19/00

(52) U.S. Cl. CPC G06F 19/3418
USPC 705/2

(57) ABSTRACT

Systems and methods are disclosed to provide automatic messaging to a client on behalf of a healthcare treatment professional by: setting up one or more computer implemented agents with rules to respond to a client condition, wherein each agent communicates with another computer implemented agent, the client or the treatment professional; during run-time, receiving a communication from the client and in response selecting one or more computer implemented agents to respond to the communication; and automatically formatting a response to be rendered on a client mobile device to encourage healthy behavior.

### BACKGROUND

This invention relates generally to interactive doctor patient communication.

Healthcare costs around the world have been rising. One reason is that, obesity is common, serious and costly. More than one-third of U.S. adults (35.7%) are obese. Obesity-related conditions increase the odds of heart disease, stroke, type 2 diabetes and certain types of cancer, some of the leading causes of preventable death. In 2008, medical costs associated with obesity were estimated at $147 billion; the medical costs for people who are obese were $1,429 higher than those of normal weight.

Obesity affects some groups more than others. Non-Hispanic blacks have the highest age-adjusted rates of obesity (49.5%) compared with Mexican Americans (40.4%), all Hispanics (39.1%) and non-Hispanic whites (34.3%). Among non-Hispanic black and Mexican-American men, those with higher incomes are more likely to be obese than those with low income. Higher income women are less likely to be obese than low-income women. There is no significant relationship between obesity and education among men. Among women, however, there is a trend—those with college degrees are less likely to be obese compared with less educated women. Thus, education appears to be key. Between 1988-1994 and 2007-2008 the prevalence of obesity increased in adults at all income and education levels.

A government solution has been suggested. For example, a ban on the use of trans fats in NY restaurants has sharply reduced the consumption of these unhealthy fats among fast-food customers. However, the government and regulation may not be the best way to solve the problem.

### BRIEF DESCRIPTION OF THE FIGURES

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, various examples discussed in the present document.

FIG. 1 is a block diagram of a network-computing environment which to provide communications between a remote computer and various hospital sites, according to embodiments as disclosed herein;

FIG. 2 is a schematic illustration showing the remote computer, a screen, and a camera for video conferencing with one or more remotely located patient sites, according to embodiments as disclosed herein;

FIG. 3 is a schematic diagram of a system in which the present invention is embodied, according to embodiments as disclosed herein;

FIG. 4 is a schematic diagram illustrating exemplary analysis of biological information received from various sources;

FIG. 5 is a pictorial illustration showing patient site environment, according to embodiments as disclosed herein;

FIG. 6 illustrates an exemplary heart disease analytics data obtained from analyzer, according to embodiments as disclosed herein;

FIG. 7 illustrates an exemplary origin of VT analytics data obtained from the analyzer, according to embodiments as disclosed herein;

FIG. 8 illustrates an exemplary obesity analytics data obtained from the analyzer, according to embodiments as disclosed herein;

FIG. 9 illustrates an exemplary diabetes analytics data obtained from the analyzer, according to embodiments as disclosed herein;

FIG. 10 is a flowchart illustrating generally, among other things an example of a method for analyzing information received from the various sources, according to embodiments as disclosed herein; and

FIG. 11 is a flowchart illustrating generally, among other things an example of a method for providing treatment recommendations to patients, according to embodiments as disclosed herein.

FIG. 12 shows an exemplary healthcare environment.

### DETAILED DESCRIPTION

In the following detailed description, reference is made to the accompanying drawings which form a part hereof, and in which is shown by way of illustration specific embodiments in which the invention may be practiced. These embodiments, which are also referred to herein as “examples,” are described in sufficient detail to enable those skilled in the art to practice the invention, and it is to be understood that the embodiments may be combined, or that other embodiments may be utilized and that structural, logical, and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a “nonexclusive or”, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The present invention provides systems, methods and associated devices for performing medical information analytics and using the analyzed information to provide effective treatment recommendations to patients. FIG. 1 shows a system 100 including a remote computer 102 communicating with a plurality of remote (or local) patient site(s) 104 over a communication network 106. The term “patient” refers to the individual(s) being diagnosed and can include the user, subject, or client at the local or remote sites. As shown in the FIG. 1, the remote computer 102 can be a medical center, office, university, or any other desired location from which one or more clinicians, doctors, physicians, or audiologists can administer treatments for the patients. In an embodiment, the diagnosis can be relayed from the remote computer 102 to a desired patient or hospital site 104 through the use of the computer network 106. The patient site 106 described herein can include, for example, but not limited to, factory or industrial office, medical related facility, hospital, general practice clinic, pediatrician's office, primary residence, home, or the like. In an embodiment, the communication network 106 described herein can include, for example, wireless network, wire-line network, Global System for Mobile communication (GSM) network, cellular network, Local Area Network (LAN), Wide Area Network (WAN), Personal Area Network (PCS), private area network, public area network, the Internet, or any other communication network. In an embodiment, the connection among the various devices present in the system 100 can be a direct connection or indirect connection, may be including intranet extranet, Virtual Private Network (VPN), the Internet or any other type of connection allowing a plurality of data processing systems 100 to communicate with each other.

In operation, the treatments can be administered by a clinician, physician, doctor, medical practitioner, or the like at the remote computer 102, remote from the patient site 104, in a manner which can allow substantially real-time interaction (typically one or more of a non-verbal, verbal, visual communication interaction, video conferencing, or the like) among the patient, clinician or doctor present at the remote site 102, and clinician or doctor present at the patient site 104 over the communication network 106. The diagnosis and recommendations can be provided to the patient based on the analysis of huge information including treatments and medical records of a plurality of patients having same (or substantially similar) diseases. The medical indications associated with the plurality of patients can be analyzed in a manner that the system 100 can meet or comply with standardized guidelines such as the American National Standards institute (“ANSI”) requirements or other agency or regulatory standards, as desired for the particular analyzing, monitoring, suggesting, recommending, treating, and the like authority in a particular jurisdiction. The different operations and the components associated with the system 100 are described in conjunction with FIG. 3.

In an embodiment, the remote computer 102 can be configured to interact with various components and devices such as to analyze the treatment information associated with the plurality of patients and provide effective treatment recommendations to the patients suffering from same (or substantially similar) diseases. Exemplary analysis of the data performed by the system 100 is described in conjunction with FIG. 4. Further, the remote computer 102 can be configured to communicate with multiple patient sites 104 at a time, at different time, or a combination thereof over the communication network 106. In an embodiment, the remote computer 102 and the patient sites 104 can be configured to use, for example, different network addresses associated with the remote site 102, the patient site 104, or any other devices present in the system 100.

FIG. 2 is a schematic illustration of a system 100 showing the remote computer 102, a screen 202, and a camera 204 for video conferencing with the one or more remotely located patient sites 104, according to embodiments as disclosed herein. The FIG. 2 shows a hospital room video-conferencing arrangement, according to the principles of the present invention as shown generally at 100. The remote computer 102 can be configured to include a video-conferencing arrangement further including a video monitor 202 and a video camera 204. The system 100 can be configured to provide remote signals to and from the remote computer 102 so that medical practitioners 206 and 208 can be enabled to communicate with nursing or medical personnel at the patient site 104. Further, the medical practitioner 208 present at the patient site 104 and the medical practitioner 206 present at the remote computer 102 can also communicate with the patient at the patient site 102 so that proper diagnosis of the patient's condition can be efficiently and accurately determined. The medical practitioners 206 and 208 described herein can typically be a licensed medical doctor and can be capable of transferring electronic control signals between the remote computer 102 and the patient site 104.

The system 100 can allow communication between the remote computer 102 and the one or more remotely located patient site(s) 104. The medical practitioner 208 can communicate with the remote computer 102 and associated medical practitioner 206 using a controller device 210. In an embodiment the controller device 210 can be configured to be operated by the medical practitioner 208 for communicating with the remote computer 102 over the communication network 106. As shown in the FIG. 2, a typical patient site 104 is provided with a bed 212 on which a patient can be located undergoing treatment. Each patient site 104 can be provided with the one or more medical practitioners (such as a nurse or other non-physician medical professional) to provide hands-on treatment, utilizing information communicated by the medical practitioner 206 via the remote computer 102. Conversely, the medical practitioner 208 can also utilize medical information communicated visually and audibly as well as by other communication links so that proper diagnosis of the patient may be performed. The medical practitioners 206 can be in video and audio communication with the medical practitioner 208 and the patient on bed 212, such as to provide the treatment to the patient in a way as if the medical practitioner 206 is present at the patient site 104. The medical practitioner 206 uses the controller unit 210 including a video camera 214 and a video monitor 216 to communicate with the remote computer 102.

FIG. 3 is a schematic diagram of the system 100 in which the present invention is embodied, according to embodiments as disclosed herein. The system 100 can be configured to include sensor(s) 302, data transceiver(s) 304, screen(s) 306, camera(s) 308, communicator(s) 310, remote computer 312, analyzer 314, and treatment recommender 316.

In an embodiment, the sensors 302 can be configured to sense the biological parameters associated with the patient. The sensors 302 can be configured to be implanted externally or internally on/in the patient body, such as to monitor the patient biological parameters. In an embodiment, the sensors 302 described herein can be implantable, non-implantable, or a combination thereof. In an example, the sensors 302 can include, but not limited to, transthoracic impedance sensor, minute ventilation sensor, respiratory rate sensor, heart monitor, accelerometer, intracardiac pressure sensor, posture sensor, hear rate monitoring sensor, weighing scale (mass sensor), blood pressure cuff (or pressure sensor), external monitor, external meters, fluid sensor, temperature sensor, or any other type of sensors capable of providing data related to patient cardiac, blood pressure, obesity, glucose level, diabetes, posture, diseases, cancer, or any other type of information associated with the patient health. In one example, the external sensor can include weighing scale which may include a digital communication link with the system 100 or which may provide data that is manually entered into different devices present in the system 100. In an embodiment, the biological parameters described herein can include, for example, but not limited to, heart rate, blood sugar level, blood pressure level, arrhythmia status, origin of arrhythmia, patient symptoms, pulse rate, patient posture information, and the like.

In an embodiment, the data transceiver 304 described herein can be configured to communicate data to the remote computer 102 over the communication network 106. The data transceiver 304 can be configured to be coupled to the sensors 302, such as to transfer the biological parameters associated with the patient. The transceiver 304 can be configured to directly or indirectly communicate with the sensors 302 over the communication network 106.

In an embodiment, the screen 306 described herein can be configured to display information associated with the patient. The screen 306 can be configured to be couple or included in the remote computer 102 and the patient site 104, such as to display a visual representation of the medical practitioners 206, 208, and the patient. Further, the medical practitioners 206 and 208 can use the screen 306 to view the patient records and other information and provide treatment recommendations to the patient. Furthermore, the medical practitioners 206 and 208 can use the screen 306 to analyze the various electronic medical records (EHR) associated with the plurality of patients. The statistic, graphical, and the like presentation of the medical information can be presented on the screen 306 to take apt decision and provide treatment recommendations for the patient(s).

In an embodiment, the camera 308 described herein can be configured to provide video conferencing between the medical practitioners 206 and 208 present at the remote computer 102 and the patient site 104. The camera 308 can be configured to be included or coupled to the remote computer 102 and the patient site 104, such as to provide video conferencing among the medical practitioners 206 and 208.

In an embodiment, the communicator 310 can be configured to provide communication between the remote computer 102 and the patient site 104. The communicator 310 can be configured to include interface/communication links to provide communication among the devices present in the system 100. The communication described herein can be direct, indirect, or a combination thereof.

In an embodiment, the remote computer 312 can be configured to provide analyzed information to the medical practitioners 206 and 208. The remote computer 312 can be configured to enable communication among the medical practitioners 204, 208, and the patient.

In an embodiment, the analyzer 314 can be configured to be coupled to or included into the remote computer 102 to make treatment recommendations by comparing medical indications related to a large population to the patient condition based on the medical sensor output. The analyzer 314 can be configured to analyze the EHRs associated with the plurality of patients to provide treatment recommendations to the patients suffering with same or similar type of diseases. Further, exemplary information analyzed by the analyzer 314 are described in conjunction with FIG. 4. In an embodiment, the treatment recommender 316 described herein can be configured to be coupled to or included into the analyzer 314 to provide a proposed treatment to the medical practitioners 206, 208, and the patient.

FIG. 4 is a schematic diagram illustrating exemplary analysis 400 of biological information received from various sources 402. In an embodiment, the analyzer 314 can be configured to receive the biological information associated with various sources. The various sources described herein can include for example, but not limited to, implantable sensors, external sensors, medical practitioner input, patient input, patients historic data, pharmaceutical databases, population/clinical data, and the like. In an embodiment, the implantable and external sensors described herein can be configured to provide data related to patient cardiac, blood pressure, obesity, glucose level, diabetes, posture, diseases, cancer, or any other type of information associated with the patient health.

In an embodiment, the medical practitioner input described herein can include an interface or data entry device accessible to a medical practitioner, medical personal or other user. Exemplary data entry devices include keyboard, mouse, trackball, controller, microphone, touch-sensitive screen, removable media storage device, PDA, or any other type of device for providing data to the analyzer 314. The data entered by the medical practitioner can include, for example, but not limited to, prescription information, medical records, patient symptoms, observation data, or any other information. In one example, the medical practitioner can be used to specify a particular value or threshold of parameters for which the analyzer 314 generates and provides treatment analytics for the patients suffering from same or similar type of diseases. The physician can be able to specify the rules and corresponding levels for generating treatment analytics for the benefit of the medical practitioners, the patient, or any other user. In an embodiment, the medical practitioner input can allow entry of medical practitioner-established rules to analyze the medical information received from various sources. For example, the medical practitioner may instruct that an analytic is generated and treatment is recommended upon detecting a particular condition (for instance, blood pressure change in excess of a particular value).

In an embodiment, the patient input can include an interface, a data entry device, a proxy device, and the like accessible by the patient or any other user. Exemplary data entry devices include keyboard, mouse, trackball, controller, microphone, touch-sensitive screen, removable media storage device, PDA, or any other device for providing data to the analyzer 314. Using the patient input, a user can be able to enter data corresponding to real time or earlier observations of the patient. In one example, the patient input can include a PDA executing a program to allow the patient to enter data such as food intake, exercise activity, perceived sensations, symptoms, posture information, and the like. The data from the PDA, or other patient input device, can be transferred to analyzer 314 by a wired or wireless connection. Further, the patient input, as with medical practitioner input, can include a data entry terminal, such as to provide the input information individually, simultaneously, parallelly, randomly, or a combination thereof.

In an embodiment, the patients historic data described herein can include an interface configured to receive information including, for example, patient EMR, clinical information system (CIS) data, or other data corresponding to a particular patient. Exemplary data includes family medical history, immunization records, patient vital signs, trends, and any other historical medical and clinical data associated with the patients. In an embodiment, the hospital or clinic information systems, bedside computer, or any other device can include details concerning to the patient's medical historic data.

In an embodiment, the pharmaceutical databases described herein can include data correlating specific drugs with medical conditions and symptoms, data generated based on research corresponding to specific geographical regions of the world, data indicating population pharmaco-kinetics for different drugs, data about the drug therapy for a particular patient, and the like. The data included, for example, correlates the effects of a drug as a function of time after taking the drug.

In an embodiment, the population/clinical data described herein can include data from different health care exchange organisations, hospitals, laboratories, clinical studies for a particular population and the like, associated with the patient suffering from same or substantially similar type of diseases. Further, the population/clinical can include data indicating relationships between selected drugs. For example, population/clinical data can include normative and statistical data showing relationships between populations and particular drugs.

In an embodiment, the analyzer 314 can be configured to associate with a large population of various data sources, such as to receive medical information associated with the plurality of patients. In an embodiment, the analyzer 314 can be configured to include analysis tools implementing various analysis functions, algorithms, logics, variables, instructions, conditions, criteria, rules, and the like, such as to analyze the information received from the various sources. Further, the analyzer 314 can be configured to generate analytics for the medical information associated with the plurality of patients suffering from same (or substantially similar) type of diseases. In an embodiment, the analytics generated by the analyzer 314 can include for example, but not limited to, heart disease analytics, diabetes analytics, influenza analytics, stroke analytics, obesity analytics, tuberculosis analytics, menstrual analytics, cancer patterns analytics, chronic lower respiratory diseases analytics, alzheimer's disease analytics, pneumonia analytics, nephritis analytics, nephrotic syndrome analytics, nephrosis analytics, and the like. The analytics described herein can be configured to provide the information related to the treatments provided to the maximum number of patients suffering from the same (or substantially similar) type of diseases, characteristics, habits, likes, dislikes, and the like.

FIG. 5 is a pictorial illustration showing patient site environment 500, according to embodiments as disclosed herein. The FIG. 5 shows the patient site 104 and showing a patient 502 lying on a bed 504 and being attended by one or more external sensors 302. Further, a medical practitioner 506 (e.g., such as nursing personnel or other non-physician medical professional) is shown to interact with the patient 502 and provide associated treatments. Further a remote computer 104, located remotely, being positioned for inspection of both the patient 502 and the medical practitioner 506 using video-conferencing with the medical practitioner 506 and perhaps with the patient 502 to enable efficient and accurate diagnosis and treatment of the patient 502. The video conferencing with among the medical practitioners present both at the remote computer 102 and the patient site 104, and the patient 506 can enable the use of the screen 306 and camera 308 present at both the remote computer 102 and the patient site 104. Furthermore, when treatment is in progress by the patient site medical practitioner, the remote computer site medical practitioner can inspect the treatment during its progress and thus ensure that optimum professional medical treatment is being accomplished.

FIG. 6 illustrates an exemplary heart disease analytics data 600 obtained from the analyzer 314, according to embodiments as disclosed herein. In an embodiment, the system 100 can be configured to analyze the data received from the various electronic sources (such as described in the FIG. 4). The FIG. 6 shows the analytics 600 generated for various heart diseases and treatments provided to the patients suffering from same or substantially similar type of the heart diseases. The heart disease analytics 600 shows the different type of heart diseases such as for example, but not limited to, atrial flutter, atrial fibrillation (AF), supraventricular tachycardia (SVT), ventricular tachycardia (VT), premature contraction (PC), ventricular fibrillation (VF), and the like, and the treatments provided to the majority of patients having similar or same type of the heart disease. For example, the analytics data shows more than 100 patients are provided the treatment-1 to the patients suffering from atrial flutter. Similarly, more than 250 patients are provided the treatments 1 and 3 to the patients suffering from the VT. Further, the heart disease analytics data 600 can be presented to the medical practitioners 206 and 208 using the remote computer 102. The medical practitioners 206 and 208 can use the heart disease analytics data to provide the heart disease treatments to the patients suffering from same or substantially similar type of the heart diseases. For example, if a patient is suffering from the SVT heart disease then the medical practitioners 206 and 208 can use the analytics data 600 (indicating that more than 200 patients are provided the treatment-3 for the SVT type of heart disease) to provide treatment recommendation for the patient. Similarly, if a patient is suffering from the PC heart disease then the medical practitioners 206 and 208 can use the analytics 600 data (indicating that more than 200 patients are provided treatment-3 for the PC type of heart diseases) to provide treatment recommendation for the patient.

FIG. 7 illustrates an exemplary origin of VT analytics data 700 obtained from the analyzer 314, according to embodiments as disclosed herein. In an embodiment, the system 100 can be configured to analyze the data received from the various electronic sources (such as described in the FIG. 4). The FIG. 7 shows the analytics data 700 generated for origin of VT and treatments provided to the patients suffering from same or substantially similar type of the VT diseases. The origin of VT analytic data 600 shows the origin of arrhythmia at different location of the heart such as for example, but not limited to, left ventricle (LV), right ventricle (RV), left atrium (LA), right atrium (RA), sino-atrial node (SA), and the appropriate treatments provided to the majority of patients based on the location of the origin of VT. For example, more than 150 patients are provided the treatment-2 for the VT originating from the RV location of the heart. Similarly, proximately 200 patients are provided the treatments 2 and 3 or the VT originating from the LA location of the heart. Further, the heart disease analytics 700 can be presented to the medical practitioners 206 and 208 using the remote computer 102. The medical practitioners 206 and 208 can use the origin of VT analytics data to provide the appropriate treatments to the patients suffering from arrhythmia starting from same or substantially similar type of heart location. For example, if a patient is suffering from the VT heart disease then the medical practitioners 206 and 208 can use the analytics 700 data (indicating that more than 250 patients is provided the treatment-7 for the VT originating from the LA) to provide the treatment recommendation for the patient. Similarly, if a patient is suffering from the VT then the medical practitioners 206 and 208 can use the analytics 600 data (indicating that more than N patients is provided the treatment-N for the VT originating from the SA) to provide the treatment recommendation for the patient.

FIG. 8 illustrates an exemplary obesity analytics data 800 obtained from the analyzer 314, according to embodiments as disclosed herein. In an embodiment, the system 100 can be configured to analyze the data received from the various electronic sources (such as described in the FIG. 4). The FIG. 8 shows the analytics 800 generated for the obesity and treatments provided to the patients suffering from same or substantially similar type of weight. The obesity analytics data 800 shows the body mass index (BMI) such as for example, but not limited to, 20, 25, 30, 35, 40, 45, and the like, and the treatments provided to the majority of patients having similar or same type of the BMI. For example, more than 150 patients are provided the treatment-1 for the patients having the BMI as 25. Similarly, more than 200 patients are provided the treatments-6 for the patients having the BMI as 40. Further, the obesity analytics data 800 can be presented to the medical practitioners 206 and 208 using the remote computer 102. The medical practitioners 206 and 208 can use the obesity analytics data 800 to provide the obesity treatments to the patients suffering from same or substantially similar BMI. For example, if a patient is having the BMI as 35 then the medical practitioners 206 and 208 can use the analytics data (indicating that more than 200 patients (having the BMI as 35) are provided the treatment-3 and 5) to provide treatment recommendation for the patient. Similarly, if a patient is having the BMI as 45 then the medical practitioners 206 and 208 can use the analytics data (indicating that more than 150 patients (having the BMI as 45) are provided the treatment-N) to provide treatment recommendation for the patient.

FIG. 9 illustrates an exemplary diabetes analytics data 900 obtained from the analyzer, according to embodiments as disclosed herein. In an embodiment, the system 100 can be configured to analyze the data received from the various electronic sources (such as described in the FIG. 4). The FIG. 9 shows the analytics data 900 generated for various blood sugar level and treatments provided to the patients suffering from same or substantially similar level of diabetes. The diabetes disease analytic data 900 shows the different levels of blood sugar (for both men and women) such as for example, but not limited to, 50, 100, 150, 200, 250, and the like, and the treatments provided to the majority of patients having similar or same levels of diabetes. For example, more than 300 patients (men's) are provided the treatment-3 for blood sugar level 100. Similarly, more than 200 patients (women's) are provided the treatments 2 and 5 for blood sugar level 100. Further, the diabetes analytics 900 can be presented to the medical practitioners 206 and 208 using the remote computer 102. The medical practitioners 206 and 208 can use the diabetes analytics data to provide the diabetes treatments to the patients suffering from same or substantially similar level of blood sugar. For example, if a patient (men) is having a blood sugar level 150 then the medical practitioners 206 and 208 can use the analytics 900 data (indicating that more than 250 patients (men's) are provided the treatment-7&3 for the blood glucose level 150) to provide treatment recommendation for the patient. Similarly, if a patient (women) is having a blood sugar level 150 then the medical practitioners 206 and 208 can use the analytics 900 data (indicating that more than 300 patients (women's) are provided the treatment-10 for the blood glucose level 150) to provide treatment recommendation for the patient.

Further, the analytics described with respect to the FIGS. 6-9 are only for illustrate purpose and the analytics data may be presented in any form. Furthermore, the system 100 may consider different parameters such as patient blood pressure, blood glucose level, patient heart rate, patient cholesterol level, patient tobacco use, patient diabetes status, patient age, patient gender, patient family history, (having a father or brother diagnosed with heart disease before a certain age or having a mother or sister diagnosed before a certain age), patient physical activities, and the like to provide treatment recommendations.

FIG. 10 is a flowchart illustrating generally, among other things an example of a method 1000 for analyzing information received from the various sources, according to embodiments as disclosed herein. In an embodiment, at 1002, the method 1000 includes receiving medical information associated with various sources. In an example, the method 1000 allows the system 100 to receive information from various sources such as for example, but not limited to, implantable sensors, external sensors, medical practitioner input, patient input, patient(s) historic data, pharmaceutical databases, population/clinical data, and the like. Further, the information can be provided by various health care exchange organisations, hospitals, laboratories, clinical studies for a particular population and the like, associated with the patient suffering from same or substantially similar type of the diseases.

In an embodiment, at 1004, the method 1000 includes analyzing the received information. In an example, the method 1000 allows the system 100 to analyze the received information based on the one or more rules. The system 100 can be configured to include various analysis tools implementing various analysis functions, algorithms, logics, variables, instructions, conditions, criteria, rules, and the like, to analyze the information received from the various sources. Further, the rules described herein can be configured to include various elements such as for example, but not limited to, patient blood pressure, patient blood glucose level, patient heart rate, patient cholesterol level, patient tobacco use, patient diabetes status, age, gender, patient family history, (having a father or brother diagnosed with heart disease before a certain age or having a mother or sister diagnosed before a certain age), the patient physical activities, and the like to analyze the received information.

In an embodiment, at 1006, the method 1000 includes generating analytics for the received information. In an example, the method 1000 allows the server 100 to generate analytics for the medical information associated with the plurality of patients suffering from same (or substantially similar) type of diseases. In an embodiment, the analytics generated by the system 100 can include for example, but not limited to, heart disease analytics, diabetes analytics, influenza analytics, stroke analytics, obesity analytics, tuberculosis analytics, menstrual analytics, cancer patterns analytics, chronic lower respiratory diseases analytics, alzheimer's disease analytics, pneumonia analytics, nephritis analytics, nephrotic syndrome analytics, nephrosis analytics, and the like. The analytics described herein can be configured to provide the information related to the treatments provided to the maximum number of patients suffering from the same (or substantially similar) type of diseases, characteristics, habits, likes, dislikes, and the like.

In an embodiment, at 1008, the method 1000 includes providing the analytics data to the medical practitioners. In an example, the method 1000 allows the system 100 to provide the analytics data to the medical practitioners, such as to provide treatment recommendations to the patients. Further, the medical practitioners can consider various parameters associated with the patient while providing the treatment recommendation. The various parameters described herein can include for example, but not limited to, patient blood pressure, patient blood glucose level, patient heart rate, patient cholesterol level, patient tobacco use, patient diabetes status, age, gender, patient family history, (having a father or brother diagnosed with heart disease before a certain age or having a mother or sister diagnosed before a certain age), the patient physical activities, patient habits, patient likes, patient dislikes, and the like.

FIG. 11 is a flowchart illustrating generally, among other things an example of a method 1100 for providing treatment recommendations to patients, according to embodiments as disclosed herein. In an embodiment, at 1102, the method 1100 includes sensing the biological parameters associated with patient(s). The biological parameters described herein can include, for example, but not limited to, heart rate, blood sugar level, blood pressure level, arrhythmia status, origin of arrhythmia, patient symptoms, pulse rate, patient posture information, and the like. In an example, the method 1100 allows the system 100 to use various implantable, non-implantable, or a combination thereof sensors implanted externally or internally on the patient to sense the biological parameters associated with the patient. The sensors described herein can include, but not limited to, transthoracic impedance sensor, minute ventilation sensor, respiratory rate sensor, heart monitor, accelerometer, intracardiac pressure sensor, posture sensor, hear rate monitoring sensor, weighing scale (mass sensor), blood pressure cuff (or pressure sensor), external monitor, external meters, fluid sensor, temperature sensor, or any other type of sensor capable of providing data related to patient cardiac, blood pressure, obesity, glucose level, diabetes, posture, diseases, cancer, or any other type of information associated with the patient health.

In an embodiment, at 1104, the method 1100 includes communicating with the remote computer 102 and medical representatives 206 and 208. In an example, the method 1100 allows the system 100 to create a communication session with the remote computer 102 and transfer the biological parameters. A video conferencing among the medical representatives 206, 208, and the patient can be provided by the system 100 to enable the communication among each other. A visual representation of the medical practitioners 206, 208, and the patient may be presented by the system 100 to allow communication among each other. Further, the medical practitioners 206 and 208 can view the patient records and other analytics data for the patients having same or substantially similar type of parameters, such as to provide treatment recommendations to the patient. Furthermore, the medical representatives 206 and 208 can frequently communicate among each other and the patient to provide effective recommendations to the patient.

In an embodiment, at 1106, the method 1100 includes using the analytics data provided by the remote computer 102. In an example, the method 1100 allows the system 100 to use the analytics data generated by the remote computer 102, such as to analyze the patient conditions and provide effective recommendations to the patient. The analytics data described herein can include the medical treatments provide to the plurality of patients associated with same (or substantially similar) type of medical information/parameters characteristics, habits, likes, dislikes, and the like. In an embodiment, the analytics provided by the system 100 can include for example, but not limited to, heart disease analytics, diabetes analytics, influenza analytics, stroke analytics, obesity analytics, tuberculosis analytics, menstrual analytics, and the like. Further, the medical probationers 206 and 208 can analyze the various electronic medical records (EHR) associated with the plurality of patients and use the statistic, graphical, and the like presentation of the analytical data to take apt decisions and provide treatment recommendations to the patients.

In an embodiment, at 1108, the method 1100 includes providing treatment recommendations to the patient. In an example, the method 1100 allows the system 100 to analyze the EHRs associated with the plurality of patients, such as to provide treatment recommendations to the patients suffering with same or similar diseases.

The various steps, blocks, units, actions, and acts described with respect to the FIGS. 10 and 11 can be performed simultaneously, parallelly, randomly, individually, or a combination thereof. Further, the various steps, blocks, units, actions, and acts can be added, deleted, skipped, and modified without departing from the scope of the invention.

Though the above description is described with respect to medical information and associated treatments but, the person skilled in art can quickly identify that the invention can be used in other business transactions and environments where active decisions, actions, and recommendations are required.

Various examples related to the cancer patterns and the associated treatments recommended using the present invention is described below. Various types of cancer can include for example, but not limited to, bladder cancer, breast cancer, colorectal cancer, kidney cancer, lung cancer, ovarian cancer, prostate cancer, and the like. In an example, the various breast cancer patterns and associated treatments recommended by the physicians using the present invention is described.

The mainstay of breast cancer treatment is surgery when the tumor is localized, with possible adjuvant hormonal therapy (with tamoxifen or an aromatase inhibitor), chemotherapy, radiotherapy, and the like. The present invention allows the physicians to use various cancer patterns and intereacton with other remote physicians to provide treatment recommendations to the patients. Depending on clinical criteria (age, type of cancer, cancer pattern, size, metastasis, X-rays of the breast, lesions detections and the like) patients are roughly divided to high risk and low risk cases, with each risk category following different rules for therapy. For example, in response to analyzing the patient breast x-ray and detecting lesions in the breast the physicians can provide the treatment recommendations such as for example, but not limited to, radiation therapy, chemotherapy, hormone therapy, and immune therapy.

In an example, FOXC1 protein expression can be analyzed using immunohistochemistry on the breast cancer tissue microarrays (TMA). Generally, strong nuclear FOXC1 staining can be found in triple-negative TMA expressing basal cytokeratins (CK5/6+ and/or CK14+) but not in non-triple-negative tumors. Cytoplasmic staining of FOXC1 can be rare, and it can be normally concomitant with nuclear staining of FOXC1. This pattern triple-negative breast cancer can be analyzed an specific treatments associated with such cancer patterns can be provided to the patients.

In an example, the treatment recommendations related to patient diabetes level is described. If the patient is suffering with high blood glucose (BG) level and the patient medical records shows that X number of consecutive readings is greater than 240, then such BG patterns of different patients are analyzed and associated treatment such as please take keytone testing may be provided to the patient. If the patient is suffering from low BG and the patients has just taken the meal then the physicians can interact with the remote physicians and analysis the BG patters of the patients whose BG level is low and just taken the meal to provide treatment recommendations to the patients. If the patient BG is 141-240 for 7 days and the patient is suffering from constant headache then the physician can analyze the BG patients of the patients with same or substantially similar BG. While considering the BG patterns the physician also analyses the headache patterns of the patients who are suffering from headache and have BG 141-240. Further, the physician can provide the treatment recommendations to the patient in accordance to the BG and the headache patterns.

In an example, the treatment recommendations related to patient diabetes is described. The system may constantly monitor the user obesity level. The system is configured to analyze standard weight and BMI (body mass index) patterns such as to determine the user obesity level. If the system determines that the user BMI is greater than or equal to 18.5 and less than 24.9 then the physician can analyze the BMI patterns of the patients suffering from same or substantially similar BMI and provide recommendations to the patients. If the system determines that the user BMI is less than 8.5 then the physician can analyze the BMI patterns of the patients suffering from same or substantially similar BMI and provide recommendations such as how much amount of calories and proteins needs to be consumed by the patient. If the patient BMI is greater than 25 and less than 29.9 then the physician can analyze the BMI patterns of the patients suffering from same or substantially similar BMI and provide recommendations such as go to gym for at least 2 hours per day and loose at least 20 calories per day. Further, the physician may measure the patient waist size such as to provide appropriate treatment recommendation to the patient. The physician may analyze the BMI patterns considering different parameters such as the patient blood pressure, blood glucose level, the patient heart rate, the patient cholesterol level, the patient tobacco use, the patient diabetes status, the patient age, the patient family history (having a father or brother diagnosed with heart disease before age 55 or having a mother or sister diagnosed before age 65), the patient physical activities, and the like to provide further exercise related recommendations to the patient. In an example, if the patient BMI is greater than 30 then the physician can analyze the BMI patterns of the patients suffering from same or substantially similar BMI and provide recommendations “you are getting obese and try losing weight”. If you want to lose weight then it's important to lose slowly. So the physician may analyze different parameters of the patient along with the BMI patterns to provide recommendations suggesting related to how much amount of calories, proteins, fat, exercise, and the like should be followed by the user.

In an embodiment, the clinical care of a particular patient can often proceeds in distinct phases, such as diagnosis before therapy, or prevention of disease before onset of disease, or rehabilitation of the patient after therapy of the patient. The analysis of queuing and renewal within human systems permitted the identification of both decision elements and potential decisions various phases of clinical care. The physicians can analyze the various disease patterns in the various phases to treatment recommendations to the patient. An exemplary phases described herein are as follows:

Decision Elements and Potential Decisions in Clinical Care.

| Phase of Care | Decision Elements | Potential Decisions |
|---|---|---|
| Prediction of Disease | Risk Factors Present | Predicted Disease |
| Prevention of Disease | Motivation of Patient | Preventive Measures |
| Diagnosis of Disease | Diagnostic Findings | Disease Diagnosis |
| Staging of Disease | Staging Factors Present | Disease Stage |
| Therapy of Patient | Pathologic States Present | Therapy Selected |
| Rehabilitation of Patient | Residual Defects Present | Schedule Selected |
| Health Status of the | Specific Load Tolerances | Specific Capacities |
| Patient | | |
| Counselling of the | Specific PatientConcerns | Specific Advice |
| Patient | | |
| Advocacy for the Patient | Specific Dangers to | Specific Defences |
| | Patient | |
| Financing for the Patient | Specific Medical | Specific Funding |
| | Expenses | |

One exemplary data flows between a user with a cell phone or mobile device in an interactive conversation with third party devices or doctors is discussed next. A patient is first registered with the system. After the user enrolls, the system starts communicating with the patient by sending the patient one or more instructions and/or reminders. Using a computer such as a mobile device the user communicates with the physician communicator engine and receives in return a custom response. At the same time, and depending on selected rules triggered by the patient response, the system sends notifications to third-party devices such as devices owned by family members or caregivers. The system can also send notifications to doctors, doctor's staff, or other authorized service providers who then send in response results that are automatically processed by the system to alter the behavior of some rules.

Next is an exemplary process for automated interactive communication between clinicians and patients. The process includes code to:

Set up rules for treatment modalities and assign zero or more rules to agent (1)

Enroll patient and assign treatment modality to patient (2)

During run time:
receiving communications from patients and selecting zero or more agents to respond to the communication (4)
receiving at zero or more event handlers messages from the zero or more responsive agents and formats the messages for a target device (6)

Another exemplary process for applying the agents of FIG. 1A to a weight loss treatment scenario. The general goals of weight loss and management are: (1) at a minimum, to prevent further weight gain; (2) to reduce body weight; and (3) to maintain a lower body weight over the long term. The initial goal of weight loss therapy is to reduce body weight by approximately 10 percent from baseline. If this goal is achieved, further weight loss can be attempted, if indicated through further evaluation. A reasonable time line for a 10 percent reduction in body weight is 6 months of therapy. For overweight patients with BMIs in the typical range of 27 to 35, a decrease of 300 to 500 kcal/day will result in weight losses of about ½ to 1 lb/week and a 10 percent loss in 6 months. For more severely obese patients with BMIs>35, deficits of up to 500 to 1,000 kcal/day will lead to weight losses of about 1 to 2 lb/week and a 10 percent weight loss in 6 months. Weight loss at the rate of 1 to 2 lb/week (calorie deficit of 500 to 1,000 kcal/day) commonly occurs for up to 6 months. After 6 months, the rate of weight loss usually declines and weight plateaus because of a lesser energy expenditure at the lower weight.

After 6 months of weight loss treatment, efforts to maintain weight loss should be put in place. If more weight loss is needed, another attempt at weight reduction can be made. This will require further adjustment of the diet and physical activity prescriptions.

Dietary Therapy: A diet that is individually planned and takes into account the patient's overweight status in order to help create a deficit of 500 to 1,000 kcal/day should be an integral part of any weight loss program. Depending on the patient's risk status, the low-calorie diet (LCD) recommended should be consistent with the NCEP's Step I or Step II Diet. Besides decreasing saturated fat, total fats should be 30 percent or less of total calories. Reducing the percentage of dietary fat alone will not produce weight loss unless total calories are also reduced. Isocaloric replacement of fat with carbohydrates will reduce the percentage of calories from fat but will not cause weight loss. Reducing dietary fat, along with reducing dietary carbohydrates, usually will be needed to produce the caloric deficit needed for an acceptable weight loss. When fat intake is reduced, priority should be given to reducing saturated fat to enhance lowering of LDL-cholesterol levels. Frequent contacts with the practitioner during dietary therapy help to promote weight loss and weight maintenance at a lower weight.

An increase in physical activity is an important component of weight loss therapy, although it will not lead to substantially greater weight loss over 6 months. Most weight loss occurs because of decreased caloric intake. Sustained physical activity is most helpful in the prevention of weight regain. In addition, it has a benefit in reducing cardiovascular and diabetes risks beyond that produced by weight reduction alone. For most obese patients, exercise should be initiated slowly, and the intensity should be increased gradually. The exercise can be done all at one time or intermittently over the day. Initial activities may be walking or swimming at a slow pace. The patient can start by walking 30 minutes for 3 days a week and can build to 45 minutes of more intense walking at least 5 days a week. With this regimen, an additional expenditure of 100 to 200 calories per day can be achieved. All adults should set a long-term goal to accumulate at least 30 minutes or more of moderate-intensity physical activity on most, and preferably all, days of the week. This regimen can be adapted to other forms of physical activity, but walking is particularly attractive because of its safety and accessibility. Patients should be encouraged to increase “every day” activities such as taking the stairs instead of the elevator. With time, depending on progress and functional capacity, the patient may engage in more strenuous activities. Competitive sports, such as tennis and volleyball, can provide an enjoyable form of exercise for many, but care must be taken to avoid injury. Reducing sedentary time is another strategy to increase activity by undertaking frequent, less strenuous activities.

The communication system is used to provide Behavior Therapy. The system automatically sends messages using rule-based agents to communicate with patients. The agents can use learning principles such as reinforcement provide tools for overcoming barriers to compliance with dietary therapy and/or increased physical activity to help patient in achieving weight loss and weight maintenance. Specific communication message include self-monitoring of both eating habits and physical activity, stress management, stimulus control, problem solving, contingency management, cognitive restructuring, and social support through the social network system.

Pharmacotherapy can be used if behavior therapy does not work. In carefully selected patients, appropriate drugs can augment LCDs, physical activity, and behavior therapy in weight loss. Drugs such as sibutramine and orlistat can be used as long as potential side effects with drugs are considered. With sibutramine, increases in blood pressure and heart rate may occur. Sibutramine should not be used in patients with a history of hypertension, CHD, congestive heart failure, arrhythmias, or history of stroke. With orlistat, fat soluble vitamins may require replacement because of partial malabsorption. Weight loss surgery is one option for weight reduction in a limited number of patients with clinically severe obesity, i.e., BMIs>=40 or >=35 with comorbid conditions. Weight loss surgery should be reserved for patients in whom efforts at medical therapy have failed and who are suffering from the complications of extreme obesity. Gastrointestinal surgery (gastric restriction [vertical gastric banding] or gastric bypass is an intervention weight loss option for motivated subjects with acceptable operative risks. An integrated program must be in place to provide guidance on diet, physical activity, and behavioral and social support both prior to and after the surgery.

The agents are adaptive to the patient and allow for program modifications based on patient responses and preferences. For example, the agent can be modified for weight reduction after age 65 to address risks associated with obesity treatment that are unique to older adults or those who smoke.

The event handler can be code to:
Receive message from patient or doctor (20)
Determine user treatment modality (22)
For each modality
   Determine relevant rules (26)
   For each rule
      Determine responsive agent(s) (30)
      For each agent
         Execute agent program (34)
         Get input from service provider if needed (36)
         Format & send the message for the patient's mobile
device (38)

The system processes a communication from a patient according to one or more treatment scenarios. Each treatment scenario is composed of one or more rules to be processed in a sequence that can be altered when invoking certain agents.

The if then rules can be described to the system using a graphical user interface that runs on a web site, a computer, or a mobile device, and the resulting rules are then processed by a rules engine. In one embodiment, the if then rules are entered as a series of dropdown selectors whose possible values are automatically determined and populated for user selection to assist user in accurately specifying the rules.

In one embodiment, the rules engine is Jess, which is a rule engine and scripting environment written entirely in Sun's Java language by Ernest Friedman-Hill at Sandia National Laboratories in Livermore, Calif. and downloadable at http://www.jessrules.com/jess/index.shtml. With Jess, the system can “reason” using knowledge supplied in the form of declarative rules. Jess is small, light, and one of the fastest rule engines available. Jess uses an enhanced version of the Rete algorithm to process rules. Rete is a very efficient mechanism for solving the difficult many-to-many matching problem (see for example “Rete: A Fast Algorithm for the Many Pattern/Many Object Pattern Match Problem”, Charles L. Forgy, Artificial Intelligence 19 (1982), 17-37.) Jess has many unique features including backwards chaining and working memory queries, and of course Jess can directly manipulate and reason about Java objects. Jess is also a powerful Java scripting environment, from which you can create Java objects, call Java methods, and implement Java interfaces without compiling any Java code.

The user can dynamically create an if/then/else statement. A dropdown selector can be used to select a column, then a dropdown to select the conditional operator (=, >, <, !=, among others) and then a text box in which to enter a column, text or number value. The system can add multiple conditions. The rules can be saved as serialized object in a database. After entering parameter values, a new set of rules can be generated and inserted within the current active scenario. The corresponding rules can then be modified directly by accessing the individual agents within the rules.

In one embodiment, the agent can be self-modifying. The agent receives parameters from its callers. The agent in turn executes one or more functions. It can include an adaptive self-modifying function, and the third-party extension interfaces. The adaptive self-modifying function is capable of modifying the agent parameters and/or the agent function at run time, thereby changing the behavior of the agent.

An exemplary modality of the rules engine can be used to serve obese patients that the doctor can review and approve. In this scenario, the engine executes 3 master agents: blood pressure master agent (50), diabetic master agent (52), and weight loss agent (54). The blood pressure master agent in turn invokes the following agents:

If blood pressure is between 130-139/85-89 mm Hg then run agent high_blood_pressure

If blood pressure is between 140-159/90-99 mm Hg then run agent stage1_blood_pressure

If blood pressure is above 159/99 mm Hg then run agent drug_treatment_for_blood_pressure

For the above example, high normal blood pressure of between 130-139/85-89 mm Hg is included in the risk stratification. In patients with high normal blood pressure with no or only one concurrent risk factor that does not include diabetes, target organ, or clinical cardiac disease, the agent high_blood_pressure suggests to the patient to use lifestyle modification to lower blood pressure. Lifestyle modification includes changes to the patient's dieting and exercising habits. With a risk factor of target organ or clinical cardiac disease, diabetes and/or other risk factors, the agent can recommend drug therapy, no matter what the patient's blood pressure is. The agent for patients with stage 1 blood pressures of between 140-159/90-99 mm Hg who have no other risk factors will suggest the patient try lifestyle modifications for a year before drug therapy is used. But if these patients have one risk factor other than diabetes, target organ, or clinical cardiac disease, their lifestyle modification should be tried for only 6 months before initiation therapy. For patients with blood pressure above 150/100 mm Hg, the agent reminds the patient to have drug therapy in addition to lifestyle modifications.

The diabetic master agent in turn invokes the following agents:
Monitoring agent: Make sure doctor orders the key tests at the right times.
Dieting planning agent: Work with a dietitian to develop a great eating plan.
Glucose Testing Agent: Check blood glucose at correct intervals.
Exercise agent: Monitor exercise to help heart.
Medication compliance agent: check that insulin is taken at correct time.
Foot care agent: Check your feet with your eyes daily.
Eye care agent: remind patient to get periodic eye exam.

The weight loss agent considers the patient's BMI, waist circumference, and overall risk status including the patient's motivation to lose weight. The weight loss agent in turn call the following agents:

Body Mass Index agent: The BMI, which describes relative weight for height, is significantly correlated with total body fat content. The BMI should be used to assess overweight and obesity and to monitor changes in body weight. In addition, measurements of body weight alone can be used to determine efficacy of weight loss therapy. BMI is calculated as weight (kg)/height squared (m2). To estimate BMI using pounds and inches, use: [weight (pounds)/height (inches)2]×703. Weight classifications by BMI, selected for use in this report, are shown below:

CLASSIFICATION OF OVERWEIGHT AND OBESITY BY BMI

| | Obesity Class | BMI (kg/m²) |
|---|---|---|
| Underweight | | <18.5 |
| Normal | | 18.5-24.9 |
| Overweight | | 25.0-29.9 |
| Obesity | I | 30.0-34.9 |
| | II | 35.0-39.9 |
| Extreme Obesity | III | ≧40 |

A conversion table of heights and weights resulting in selected BMI units is

SELECTED BMI UNITS CATEGORIED BY INCHES (CM)
AND POUNDS (KG).

| | BMI 25 kg/m² | BMI 27 kg/m² | BMI 30 kg/m² |
|---|---|---|---|
| Height in inches (cm) | Body weight in pounds (kg) | | |
| 58 (147.32) | 119 (53.98) | 129 (58.51) | 143 (64.86) |
| 59 (149.86) | 124 (56.25) | 133 (60.33) | 148 (67.13) |
| 60 (152.40) | 128 (58.06) | 138 (62.60) | 153 (69.40) |
| 61 (154.94) | 132 (59.87) | 143 (64.86) | 158 (71.67) |
| 62 (157.48) | 136 (61.69) | 147 (66.68) | 164 (74.39) |
| 63 (160.02) | 141 (63.96) | 152 (68.95) | 169 (76.66) |
| 64 (162.56) | 145 (65.77) | 157 (71.22) | 174 (78.93) |
| 65 (165.10) | 150 (68.04) | 162 (73.48) | 180 (81.65) |
| 66 (167.64) | 155 (70.31) | 167 (75.75) | 186 (84.37) |
| 67 (170.18) | 159 (72.12) | 172 (78.02) | 191 (86.64) |
| 68 (172.72) | 164 (74.39) | 177 (80.29) | 197 (89.36) |
| 69 (175.26) | 169 (76.66) | 182 (82.56) | 203 (92.08) |
| 70 (177.80) | 174 (78.93) | 188 (85.28) | 207 (93.90) |
| 71 (180.34) | 179 (81.19) | 199 (87.54) | 215 (97.52) |
| 72 (182.88) | 184 (83.46) | 199 (90.27) | 221 (100.25) |
| 73 (185.42) | 189 (85.73) | 204 (92.53) | 227 (102.97) |
| 74 (187.96) | 194 (88.00) | 210 (95.26) | 233 (105.69) |
| 75 (190.50) | 200 (90.72) | 216 (97.98) | 240 (108.86) |
| 76 (199.04) | 205 (92.99) | 221 (100.25) | 246 (111.59) |

| Metric conversion formula = | Non-metric conversion formula = |
|---|---|
| weight (kg)/height (m)² | [weight (pounds)/height (inches)²] × 704.5 |
| Example of BMI calculation: | Example of BMI calculation: |
| A person who weight | A person who weight 154 pounds and is |
| 78.93 kilograms and is 127 | 68 inches (or 5′ 8′) tall has a BMI of 25: |
| centimeters tall has a BMI of | [weight (164 pounds/height (68 inches)²] × |
| 25: weight (78.93 kg)/ | 704.5 = 25 |
| height (1.77 m)² = 25 | |

Waist Circumference agent: The presence of excess fat in the abdomen out of proportion to total body fat is an independent predictor of risk factors and morbidity. Waist circumference is positively correlated with abdominal fat content. It provides a clinically acceptable measurement for assessing a patient's abdominal fat content before and during weight loss treatment. The sex-specific cutoffs noted on the next page can be used to identify increased relative risk for the development of obesity-associated risk factors in most adults with a BMI of 25 to 34.9 kg/m2: These waist circumference cutpoints lose their incremental predictive power in patients with a BMI>=35 kg/m2 because these patients will exceed the cutpoints noted above. The disease risk of increased abdominal fat to the disease risk of BMI is as follows:

CLASSIFICATION OF OVERWEIGHT AND OBESITY BY BMI, WAIST
CIRCUMFERENCE AND ASSOCIATED DISEASE RISKS

| | | | Disease Risk * Relative to Normal Weight | |
|---|---|---|---|---|
| | | | and Waist Circumference | |
| | | Obesity | Men ≦102 cm (≦40 in) | >102 cm (>40 in) |
| | BMI (kg/m²) | Class | Women ≦88 cm (≦35 in) | >88 cm (>35 in) |
| Underweight | <18.5 | | — | — |
| Normal* | 18.5-24.9 | | — | — |
| Overweight | 25.0-29.9 | | increased | High |
| Obesity | 30.0-34.9 | I | High | Very High |
| | 35.0-39.9 | II | Very High | Very High |
| Extreme Obesity | ≧40 | III | Extremely High | Extremely High |

These categories denote relative risk, not absolute risk; that is, relative to risk at normal weight. They should not be equated with absolute risk, which is determined by a summation of risk factors. They relate to the need to institute weight loss therapy and do not directly define the required intensity of modification of risk factors associated with obesity.

Risk Status agent is used for assessment of a patient's absolute risk status and in turn uses the following agents:
1) Disease condition agent: determine existence of coronary heart disease (CHD), other atherosclerotic diseases, type 2 diabetes, and sleep apnea.
2) Obesity-associated disease agent: determines gynecological abnormalities, osteoarthritis, gallstones and their complications, and stress incontinence.
3) Cardiovascular risk factors agent: cigarette smoking, hypertension (systolic blood pressure>=140 mm Hg or diastolic blood pressure>=90 mm Hg, or the patient is taking antihypertensive agents), high-risk LDL-cholesterol (>=160 mg/dL), low HDL-cholesterol (<35 mg/dL), impaired fasting glucose (fasting plasma glucose of 110 to 125 mg/dL), family history of premature CHD (definite myocardial infarction or sudden death at or before 55 years of age in father or other male first-degree relative, or at or before 65 years of age in mother or other female first-degree relative), and age (men>=45 years and women>=55 years or postmenopausal). Patients can be classified as being at high absolute risk if they have three of the aforementioned risk factors. Patients at high absolute risk usually require clinical management of risk factors to reduce risk. Patients who are overweight or obese often have other cardiovascular risk factors. Methods for estimating absolute risk status for developing cardiovascular disease based on these risk factors are described in detail in the National Cholesterol Education Program's Second Report of the Expert Panel on the Detection, Evaluation, and Treatment of High Blood Cholesterol in Adults (NCEP's ATP II) and the Sixth Report of the Joint National Committee on Prevention, Detection, Evaluation, and Treatment of High Blood Pressure (JNC VI). The intensity of intervention for cholesterol disorders or hypertension is adjusted according to the absolute risk status estimated from multiple risk correlates. These include both the risk factors listed above and evidence of end-organ damage present in hypertensive patients. Approaches to therapy for cholesterol disorders and hypertension are described in ATP II and JNC VI, respectively. In overweight patients, control of cardiovascular risk factors deserves equal emphasis as weight reduction therapy. Reduction of risk factors will reduce the risk for cardiovascular disease whether or not efforts at weight loss are successful.

Other risk factors can be considered as rules by the agent, including physical inactivity and high serum triglycerides (>200 mg/dL). When these factors are present, patients can be considered to have incremental absolute risk above that estimated from the preceding risk factors. Quantitative risk contribution is not available for these risk factors, but their presence heightens the need for weight reduction in obese persons.

A patient motivation agent evaluates the following factors: reasons and motivation for weight reduction; previous history of successful and unsuccessful weight loss attempts; family, friends, and work-site support; the patient's understanding of the causes of obesity and how obesity contributes to several diseases; attitude toward physical activity; capacity to engage in physical activity; time availability for weight loss intervention; and financial considerations. In addition to considering these issues, the system can heighten a patient's motivation for weight loss and prepare the patient for treatment through normative messaging and warnings. This can be done by enumerating the dangers accompanying persistent obesity and by describing the strategy for clinically assisted weight reduction. Reviewing the patients' past attempts at weight loss and explaining how the new treatment plan will be different can encourage patients and provide hope for successful weight loss.

FIG. 12 shows an exemplary patient monitoring system. The system can operate in a home, a care facility, a nursing home, or a hospital. In this system, one or more mesh network appliances 8 are provided to enable wireless communication in the home monitoring system. Appliances 8 in the mesh network can include home security monitoring devices, door alarm, window alarm, home temperature control devices, fire alarm devices, among others. Appliances 8 in the mesh network can be one of multiple portable physiological transducer, such as a blood pressure monitor, heart rate monitor, weight scale, thermometer, spirometer, single or multiple lead electrocardiograph (ECG), a pulse oxymeter, a body fat monitor, a cholesterol monitor, a signal from a medicine cabinet, a signal from a drug container, a signal from a commonly used appliance such as a refrigerator/stove/oven/washer, or a signal from an exercise machine, such as a heart rate. As will be discussed in more detail below, one appliance is a patient monitoring device that can be worn by the patient and includes a single or bi-directional wireless communication link, generally identified by the bolt symbol in FIG. 1, for transmitting data from the appliances 8 to the local hub or receiving station or base station server 20 by way of a wireless radio frequency (RF) link using a proprietary or non-proprietary protocol. For example, within a house, a user may have mesh network appliances that detect window and door contacts, smoke detectors and motion sensors, video cameras, key chain control, temperature monitors, CO and other gas detectors, vibration sensors, and others. A user may have flood sensors and other detectors on a boat. An individual, such as an ill or elderly grandparent, may have access to a panic transmitter or other alarm transmitter. Other sensors and/or detectors may also be included. The user may register these appliances on a central security network by entering the identification code for each registered appliance/device and/or system. The mesh network can be Zigbee network or 802.15 network. More details of the mesh network is shown in FIG. 7 and discussed in more detail below. An interoperability protocol supports the automatic configuration of an appliance with the base station. When the user operates a new appliance, the appliance announces its presence and the base station detects the presence and queries the device for its identity. If the device is not recognized, the base station determines where to find the needed software, retrieves the software, install the support software for the appliance, and then ran the device's default startup protocol that came in the downloaded installation package. The protocol allows remotely located systems or users to authenticate the identity (and possibly credentials) of the persons or organizations with whom they are interacting and ensures the privacy and authenticity of all data and command flowing between the appliances and any internal or external data storage devices. A public key infrastructure or cryptographic mechanism for facilitating these trusted interactions is used to support a global e-medicine system infrastructure. The protocol allows independently designed and implemented systems to locate each other, explore each other's capabilities (subject to each station's access control rules), to negotiate with each other and with the networks that they will use to determine how a given session will be run (for example, what Quality of Service requirements will be levied and what resources will be leased from each other), and to then conduct collaborative operations. The protocol contains instructions regarding the kinds of components that are needed to support the protocol's operation, the ways in which these components need to be interconnected, and events that are to be monitored during the time that the protocol is active.

A plurality of monitoring cameras 10 may be placed in various predetermined positions in a home of a patient 30. The cameras 10 can be wired or wireless. For example, the cameras can communicate over infrared links or over radio links conforming to the 802X (e.g. 802.11A, 802.11B, 802.11G, 802.15) standard or the Bluetooth standard to a base station/server 20 may communicate over various communication links, such as a direct connection, such a serial connection, USB connection, Firewire connection or may be optically based, such as infrared or wireless based, for example, home RF, IEEE standard 802.11a/b, Bluetooth or the like. In one embodiment, appliances 8 monitor the patient and activates the camera 10 to capture and transmit video to an authorized third party for providing assistance should the appliance 8 detects that the user needs assistance or that an emergency had occurred.

The base station/server 20 stores the patient's ambulation pattern and vital parameters and can be accessed by the patient's family members (sons/daughters), physicians, caretakers, nurses, hospitals, and elderly community. The base station/server 20 may communicate with the remote server 200 by DSL, T-1 connection over a private communication network or a public information network, such as the Internet 100, among others.

The patient 30 may wear one or more wearable patient monitoring appliances such as wrist-watches or clip on devices or electronic jewelry to monitor the patient. One wearable appliance such as a wrist-watch includes sensors 40, for example devices for sensing ECG, EKG, blood pressure, sugar level, among others. In one embodiment, the sensors 40 are mounted on the patient's wrist (such as a wristwatch sensor) and other convenient anatomical locations. Exemplary sensors 40 include standard medical diagnostics for detecting the body's electrical signals emanating from muscles (EMG and EOG) and brain (EEG) and cardiovascular system (ECG). Leg sensors can include piezoelectric accelerometers designed to give qualitative assessment of limb movement. Additionally, thoracic and abdominal bands used to measure expansion and contraction of the thorax and abdomen respectively. A small sensor can be mounted on the subject's finger in order to detect blood-oxygen levels and pulse rate. Additionally, a microphone can be attached to throat and used in sleep diagnostic recordings for detecting breathing and other noise. One or more position sensors can be used for detecting orientation of body (lying on left side, right side or back) during sleep diagnostic recordings. Each of sensors 40 can individually transmit data to the server 20 using wired or wireless transmission. Alternatively, all sensors 40 can be fed through a common bus into a single transceiver for wired or wireless transmission. The transmission can be done using a magnetic medium such as a floppy disk or a flash memory card, or can be done using infrared or radio network link, among others. The sensor 40 can also include an indoor positioning system or alternatively a global position system (GPS) receiver that relays the position and ambulatory patterns of the patient to the server 20 for mobility tracking.

In one embodiment, the sensors 40 for monitoring vital signs are enclosed in a wrist-watch sized case supported on a wrist band. The sensors can be attached to the back of the case. For example, in one embodiment, Cygnus' AutoSensor (Redwood City, Calif.) is used as a glucose sensor. A low electric current pulls glucose through the skin. Glucose is accumulated in two gel collection discs in the AutoSensor. The AutoSensor measures the glucose and a reading is displayed by the watch.

In another embodiment, EKG/ECG contact points are positioned on the back of the wrist-watch case. In yet another embodiment that provides continuous, beat-to-beat wrist arterial pulse rate measurements, a pressure sensor is housed in a casing with a ‘free-floating’ plunger as the sensor applanates the radial artery. A strap provides a constant force for effective applanation and ensuring the position of the sensor housing to remain constant after any wrist movements. The change in the electrical signals due to change in pressure is detected as a result of the piezoresistive nature of the sensor are then analyzed to arrive at various arterial pressure, systolic pressure, diastolic pressure, time indices, and other blood pressure parameters.

The case may be of a number of variations of shape but can be conveniently made a rectangular, approaching a box-like configuration. The wrist-band can be an expansion band or a wristwatch strap of plastic, leather or woven material. The wrist-band further contains an antenna for transmitting or receiving radio frequency signals. The wristband and the antenna inside the band are mechanically coupled to the top and bottom sides of the wrist-watch housing. Further, the antenna is electrically coupled to a radio frequency transmitter and receiver for wireless communications with another computer or another user. Although a wrist-band is disclosed, a number of substitutes may be used, including a belt, a ring holder, a brace, or a bracelet, among other suitable substitutes known to one skilled in the art. The housing contains the processor and associated peripherals to provide the human-machine interface. A display is located on the front section of the housing. A speaker, a microphone, and a plurality of push-button switches and are also located on the front section of housing. An infrared LED transmitter and an infrared LED receiver are positioned on the right side of housing to enable the watch to communicate with another computer using infrared transmission.

In another embodiment, the sensors 40 are mounted on the patient's clothing. For example, sensors can be woven into a single-piece garment (an undershirt) on a weaving machine. A plastic optical fiber can be integrated into the structure during the fabric production process without any discontinuities at the armhole or the seams. An interconnection technology transmits information from (and to) sensors mounted at any location on the body thus creating a flexible “bus” structure. T-Connectors—similar to “button clips” used in clothing—are attached to the fibers that serve as a data bus to carry the information from the sensors (e.g., EKG sensors) on the body. The sensors will plug into these connectors and at the other end similar T-Connectors will be used to transmit the information to monitoring equipment or personal status monitor. Since shapes and sizes of humans will be different, sensors can be positioned on the right locations for all patients and without any constraints being imposed by the clothing. Moreover, the clothing can be laundered without any damage to the sensors themselves. In addition to the fiber optic and specialty fibers that serve as sensors and data bus to carry sensory information from the wearer to the monitoring devices, sensors for monitoring the respiration rate can be integrated into the structure.

In another embodiment, instead of being mounted on the patient, the sensors can be mounted on fixed surfaces such as walls or tables, for example. One such sensor is a motion detector. Another sensor is a proximity sensor. The fixed sensors can operate alone or in conjunction with the cameras 10. In one embodiment where the motion detector operates with the cameras 10, the motion detector can be used to trigger camera recording. Thus, as long as motion is sensed, images from the cameras 10 are not saved. However, when motion is not detected, the images are stored and an alarm may be generated. In another embodiment where the motion detector operates stand alone, when no motion is sensed, the system generates an alarm.

The server 20 also executes one or more software modules to analyze data from the patient. A module 50 monitors the patient's vital signs such as ECG/EKG and generates warnings should problems occur. In this module, vital signs can be collected and communicated to the server 20 using wired or wireless transmitters. In one embodiment, the server 20 feeds the data to a statistical analyzer such as a neural network which has been trained to flag potentially dangerous conditions. The neural network can be a back-propagation neural network, for example. In this embodiment, the statistical analyzer is trained with training data where certain signals are determined to be undesirable for the patient, given his age, weight, and physical limitations, among others. For example, the patient's glucose level should be within a well established range, and any value outside of this range is flagged by the statistical analyzer as a dangerous condition. As used herein, the dangerous condition can be specified as an event or a pattern that can cause physiological or psychological damage to the patient. Moreover, interactions between different vital signals can be accounted for so that the statistical analyzer can take into consideration instances where individually the vital signs are acceptable, but in certain combinations, the vital signs can indicate potentially dangerous conditions. Once trained, the data received by the server 20 can be appropriately scaled and processed by the statistical analyzer. In addition to statistical analyzers, the server 20 can process vital signs using rule-based inference engines, fuzzy logic, as well as conventional if-then logic. Additionally, the server can process vital signs using Hidden Markov Models (HMMs), dynamic time warping, or template matching, among others.

Through various software modules, the system reads video sequence and generates a 3D anatomy file out of the sequence. The proper bone and muscle scene structure are created for head and face. A based profile stock phase shape will be created by this scene structure. Every scene will then be normalized to a standardized viewport.

A module monitors the patient ambulatory pattern and generates warnings should the patient's patterns indicate that the patient has fallen or is likely to fall. 3D detection is used to monitor the patient's ambulation. In the 3D detection process, by putting 3 or more known coordinate objects in a scene, camera origin, view direction and up vector can be calculated and the 3D space that each camera views can be defined.

In one embodiment with two or more cameras, camera parameters (e.g. field of view) are preset to fixed numbers. Each pixel from each camera maps to a cone space. The system identifies one or more 3D feature points (such as a birthmark or an identifiable body landmark) on the patient. The 3D feature point can be detected by identifying the same point from two or more different angles. By determining the intersection for the two or more cones, the system determines the position of the feature point. The above process can be extended to certain feature curves and surfaces, e.g. straight lines, arcs; flat surfaces, cylindrical surfaces. Thus, the system can detect curves if a feature curve is known as a straight line or arc. Additionally, the system can detect surfaces if a feature surface is known as a flat or cylindrical surface. The further the patient is from the camera, the lower the accuracy of the feature point determination. Also, the presence of more cameras would lead to more correlation data for increased accuracy in feature point determination. When correlated feature points, curves and surfaces are detected, the remaining surfaces are detected by texture matching and shading changes. Predetermined constraints are applied based on silhouette curves from different views. A different constraint can be applied when one part of the patient is occluded by another object. Further, as the system knows what basic organic shape it is detecting, the basic profile can be applied and adjusted in the process.

In a single camera embodiment, the 3D feature point (e.g. a birth mark) can be detected if the system can identify the same point from two frames. The relative motion from the two frames should be small but detectable. Other features curves and surfaces will be detected correspondingly, but can be tessellated or sampled to generate more feature points. A transformation matrix is calculated between a set of feature points from the first frame to a set of feature points from the second frame. When correlated feature points, curves and surfaces are detected, the rest of the surfaces will be detected by texture matching and shading changes.

Each camera exists in a sphere coordinate system where the sphere origin (0,0,0) is defined as the position of the camera. The system detects theta and phi for each observed object, but not the radius or size of the object. The radius is approximated by detecting the size of known objects and scaling the size of known objects to the object whose size is to be determined. For example, to detect the position of a ball that is 10 cm in radius, the system detects the ball and scales other features based on the known ball size. For human, features that are known in advance include head size and leg length, among others. Surface texture can also be detected, but the light and shade information from different camera views is removed. In either single or multiple camera embodiments, depending on frame rate and picture resolution, certain undetected areas such as holes can exist. For example, if the patient yawns, the patient's mouth can appear as a hole in an image. For 3D modeling purposes, the hole can be filled by blending neighborhood surfaces. The blended surfaces are behind the visible line.

In FIG. 12, the exemplary devices 8, 10, and 40 include a layer of device-specific software (application interface) which supports a common language (such as, for example, the Extension Markup Language (XML)) to interface with the base station or local server 20. The base station 20 acts as a gateway or moderator to coordinate the devices 8, 10 and 40 in a local network neighborhood. The base station 20 supports multiple communication protocols and connectivity standards so that it may talk to other devices in one language (e.g., XML) but using different protocols and/or connectivity standards (such as, for example, Hypertext Transfer Protocol (HTTP), File Transfer Protocol (FTP), Simple Network Management Protocol (SNMP), Internet Inter-Orb Protocol (HOP) in Common Object Request Broken Architecture (CORBA), Simple Object Access Protocol (SOAP) with Extension Markup Language (XML), Ethernet, Bluetooth, IEEE 802.11 a/b/g (WiFi), 802.16 (WiMAX), ZigBee, Infrared Detection and Acquisition (IrDA), General Packet Radio Service (GPRS), Code Division Multiplexed Access (CDMA), and Global System for Mobile Communication (GSM), or any other appropriate communications protocol or connectivity standard). The base station 20 performs device registration, synchronization, and user authentication and authorization. The application interface provides a simplified way of communicating with the base station 40 which provides a seamless integration and synchronization among the devices 8, 10 and 40 for example. Hence, instead of connecting individual devices directly (point-to-point) to a network, such as, for example, the Internet, to obtain services, the base station 20 runs a “middleware” software that hides protocol and connectivity details from the device. Consequently, services from the Internet, for example, may be provided without being concerned about future development of new protocols, services, and connectivity.

To obtain services from external sources, the base station 20 makes a request based on the information collected from the multiple devices and issues the request to the remote server 200. The remote server 200 acts as a proxy/gateway to request, consume, and/or distribute web services from a variety of content sources. In this regard, the communications between the base station 20 and the server 200 are encrypted to protect patient identifiable information and other private details of the person. Also, a variety of services may be aggregated and cached, thus providing a faster response time and better use of network bandwidth. The server 200 may store information regarding the devices and/or service providers. In this regard, the server 200 may include a user profile database that maintains an updated copy of the user profile and application data so that intelligent content services and synchronization among different devices may be provided. In a wireless network environment, availability may not always be guaranteed so that another mechanism, such as, for example, a queue structure, may be required to save the data, profiles, and results for later retrieval.

The devices 8, 10 and 40 register with the base station 20 and provide information regarding the capabilities of the device, including, for example, device type (EKG, EMG, blood pressure sensor, etc.) memory size, processing capacity, and supported protocols and connectivity. The base station 20 processes service requests from the devices and may enhance the service requests and/or combine them collectively before issuing the requests in response to queries from a requester such as a doctor who polls the server 200 on the status of the patient. Upon receiving the request from the doctor through the server 200, the base station 20 “tailors” the request to suit the proper device capability before relaying it the appropriate device. Hence, the devices 8, 10 and 40, issue requests on behalf of themselves and receive responses individually according to their particular capabilities while the base station 40 customizes and combines requests/responses to simplify and/or improve communication efficiency. Data is automatically synchronized to maintain a consistent state of the devices, regardless, for example, of network availability and/or unreliable networks.

Next, an exemplary process for providing interoperability between two devices within the base station network (such as devices 8, 10 and 40) is described. Pseudo-code for the device interoperability process is as follows:
Device requests registration with base station (S2)
Base station registers devices with remote server on their behalf (S4)
Device requests application data from base station (S6)
Base station searches for a responsive device from its registration list and forwards request to responsive device over preferred communication channel (S8)
Responsive device replies to base station with data (S10)
Base station reformats data to match requesting data's preference (S12)
Base station forwards formatted data to requesting device on requesting device's communication channel (S14)

In the next example, an exemplary process for providing interoperability between a device within the base station network (such as one of devices 8, 10 and 40) and an external device (such as a cell phone) is described. Pseudo-code for the device interoperability process is as follows:
Cell phone and In-Network Devices requests registration with base station (S22)
Base station registers devices with remote server on their behalf (S24)
Cell phone requests application data from base station (S26)
Base station searches for a responsive device from its registration list and forwards request to responsive device over preferred communication channel (S28)
Responsive device replies to base station with data (S30)
Base station reformats data to match cell phone's preference, in this example SMS (S32)
Base station forwards SMS formatted data to cell phone over cellular channel (S34).

In S24, the base station registers the devices, including their connectivity and protocol capabilities. During the registration, the base station determines, for example, that the EKG monitor device supports IEEE 802.15.4 connectivity standard (ZigBee) and the cellular telephone supports Bluetooth and SMS messaging. In S26, the cell phone may trigger an application supported by the EKG device. In S28, the base station receives the request and searches for a registered device that supports that application. For example, base station searches a device table and finds that the cellular telephone is able to process SMS messages and the EKG monitoring device can communicate over ZigBee and stores data in the OpenEKG format. In step S28, the base station relays the application request to the EKG monitoring device. The monitoring device captures EKG data from the patient and sends the data to the base station. In S32, the base station reformats data to SMS message format and to send the SMS message to the requesting cell phone. In this regard, the exemplary system may provide a transparent SMS service to the cell phone from a Zigbee device. Hence, from a receiving device perspective, the cell phone thinks that the EKG monitoring device is sending and receiving SMS messages, but the EKG monitoring device is not able to perform SMS messaging by itself. The translation is transparently and automatically done by the base station.

In the following example, an exemplary process for providing interoperability between a device within the base station network (such as one of devices 8, 10 and 40) and an external device at a clinic or hospital is described. Pseudo-code for the device interoperability process is as follows:
Hospital/Clinic devices and In-Network devices requests registration with remote server (S42)
Remote server forwards registration request to all base stations, which in turn register hospital/clinic device (S44)
Hospital device requests application data from server, which in turn forwards request to base station (S46)
Base station searches for a responsive device from its registration list and forwards request to responsive device over preferred communication channel (S48)
Responsive device replies to base station with data (S50)
Base station reformats data to match requestor's preference (S52)
Base station forwards formatted data to hospital/clinic device through the remote server (S54)

In this example, a doctor at a hospital, clinic or doctor office registers and authenticates with the remote server 200. In a thin-client application, the server 200 maintains all patient information in its database. Upon authentication, the server 200 polls the base station for the latest information and displays the patient screens for the doctor. In this case, the server 200 uses secure HTTP (SHTTP) protocol for communication with the base station 20 and the base station performs auto-translation among devices. For example, a hospital EKG device can store time series EKG data in XML format, while a home based EKG device can store compressed EKG data. The base station can translate the Open EKG format to the uncompressed XML data.

In another embodiment, instead of having the doctor using a thin-client, a remote user such as a patient representative (attorney in fact), family member, or a doctor can be running his/her own computer system that is registered with the server 200 as an authorized user. The server 200 forwards such registration to the base station 20 and the base station registers the doctor's computer as an authorized doctor base station in the network. The doctor base station in turn communicates with devices in the doctor's office such as digital scales, blood pressure measurement devices, digital X-ray machines, glucose measurement devices, digital scanners such as computer aided tomography (CAT) scanners and nuclear magnetic resonance (NMR) scanners, among others. These devices capture patient information through a unique patient identifier and the data is stored in the doctor base station and can also be uploaded to the remote server 200 to store data. Since numerous base stations can exist that provide medical information on a patient (different doctors/specialists, different hospitals and care centers), the server 200 performs data synchronization to ensure that all base stations have access to the latest information.

To allow the remote person such as a physician or a family member to monitor a patient, a plurality of user interface modules enable the remote person to control each appliance and to display the data generated by the appliance. In one example scenario, an EKG sensor wirelessly communicates with the patient base station and outputs a continuous EKG waveform. A pattern recognizer or analyzer positioned at the doctor's station accepts waveform data and generates a variety of statistics that characterize the waveform and can generate alarms or messages to the doctor if certain predefined conditions are met. While it is operating, the EKG sends its waveform data to its subscribing components or modules at the doctor's office and the analyzer processes the data and sends summaries or recommendations to the doctor for viewing. If, during the operation of this network of components, any of these components experience an event that compromises its ability to support the protocol (e.g., the EKG unit is disconnected or deactivated from the base station), then the affected components notify the remote base station of a disconnected appliance. When finished with the EKG data sampling, the user may “deselect” the device on the user interface framework, which results in the EKG user interface module being disabled and terminating data collection by the EKG device. In turn, the protocol instructs each of the leased components to terminate its subscriptions. The protocol then notifies the registry that it is vacating its lease on these components and tells the user interface event handler that it is ending.

The system can support procedure-centric workflow management such as those described in Application Serial No. 20060122865. In one example, the system manages a workflow involving a specialist, an electronic medial record (EMR) or other external patient information system, a referring provider, a rural health care facility, and appropriate appliances (e.g., modalities) corresponding to the particular procedure of interest. In one example, the specialist's workflow includes capturing/reviewing patient history, which itself entails reviewing prior procedures, reviewing prior data and/or digital images, reviewing problem lists in communication with the EMR, capturing/reviewing patient physical and history information in communication with EMR, and reviewing lab results in communication with EMR. The workflow further includes capturing follow-up orders in communication with EMR. In addition, the workflow also involves capturing procedure results and corresponding data obtained during the procedure, and distributing such data in communication with a referring provider and rural facility. Finally, in communication with external devices or appliances, the specialist receives the captured data from the procedure and reviews/interprets the data or digital images. Workflow management as described here includes recognition of various roles of people involved in workflows, whether they are different types of caregivers or different types of patients.

In one embodiment, the authentication source is a trusted key distribution center (KDC) and the authentication type is user IDs with passwords. The initial authentication can also be based on public key. The public key infrastructure (PKI) system can be used where the authentication source is a certificate authority (CA) and the authentication type is challenge/response. Another authentication system called the secure remote password (SRP) protocol authenticates clients to servers securely, in cases where the client must memorize a small secret (like a password) and carries no other secret information, and where the server carries a verifier which allows it to authenticate the client but which, if compromised, would not allow someone to impersonate the client.

The system may be based on a peer-to-peer (P2P) architecture rather than a client-server approach. In this exemplary architecture, each participating device, that is, each peer, belongs to a peer group, such as, for example, a local area impromptu network neighborhood formed by nearby devices through authentication and authorization. Each device communicates to a router, residing, for example, on another device. The router may also function as a device except that it may be additionally responsible for device synchronization, device registration, authentication, authorization, and obtaining services from service providers. The device router may aggregate the service requests from each device to form a single query and may be required to have a suitable connectivity/bandwidth to the service provider to obtain responses. To accommodate unreliable networks, the router may also store or cache the requests and results so that if the devices become disconnected a reconnection and resend of the request may be performed. According to an exemplary embodiment, at least one device router should exist in the peer group. As devices join and leave the network, their roles may change. For example, a more capable (e.g., faster connectivity or higher computation power) device may become the router. Hence, a flexible and dynamic network topology may be provided.

Interprocess communication in a heterogeneous distributed environment may require support for different language bindings (e.g., C, C++, Java, etc.), different protocols (e.g., HTTP, HOP, RMI, HTTPS, SOAP, XML, XML-RPC, etc.) and different frameworks (e.g., CORBA, OS sockets, JMS, Java object serialization, etc). A Message Oriented Middleware (MoM) may be provided which runs continuously (e.g., acting as a server middleware) to regulate and facilitate the exchange of messages between publishers (those who “announce”) and subscribers (those who “listen”). The message may be described with XML-encoded Meta information. Message data may include simple ASCII text, GIF images, XML data, Java objects, or any binary-encoded data. Other protocols, such as, for example, E-mail or SOAP may be plugged in later without making any changes in the client code. The MoM may hide much of the networking protocol and operating system issues, which should alleviate the burden of maintaining socket communication and session management from programmers.

In one embodiment, a device first appears on a network. The device searches the local cache for information regarding the base station. If base station information is found, the device attempts to contact the base station and setup a connection. Otherwise if the information is not found, then a discovery request is sent. The discovery request may be sent via a broadcast or a multicast. In this regard, the device sends out a discovery request and all the devices in the network neighborhood should receive the message and respond appropriately. The device agent examines the responses to determine and/or confirm the base station. If the device does not discover the base station, the system assumes that there is no base station in the network neighborhood at present and repeats the discovery request process until a base station is found. Otherwise, if the device discovers the base station, the connection token is saved (an XML message that tells where the device communicator is located and how to contact it) in the cache for later usage. The cache may allow for faster discovery but it may also expire due to the feature that devices may join and leave the network. Therefore a time-to-live (TTL) may be attached so that after a certain period the cached data may be considered expired. A check may also be preformed to ensure that the device exists before a network connection is initiated. To provide a generalized format, XML may be used to provide an easily expandable and hierarchical representation. XML may also be used to aggregate information from other agents and send back results from service providers to device through the base station.

A multitude of standards address mid to high data rates for voice, PC LANs, video, among others. ZigBee provides good bandwidth with low latency and very low energy consumption for long battery lives and for large device arrays. Bluetooth provides higher speed (and higher power consumption) for cell phone headset applications, among others. Variants of the 802.11 standard (802.11b, 802.11g, 802.11a) provide yet faster data transmission capability with correspondingly high power consumption. Other devices include WiMAX (802.16) and ultrawideband devices that are very high in power consumption and provide long range and/or video capable transmission.

Device discovery and service discovery are provided for each class of devices (Zigbee or Bluetooth, for example). For interoperability, a local discovery mapper running on the personal server or a remote discovery mapper running on a remote server is provided to enable Zigbee services to be advertised to Bluetooth devices and vice versa, for example. In other implementations, the services of ZigBee devices can be advertised to body PAN devices (PAN devices that are attached to a biological being such as humans or pets), Bluetooth devices, cellular devices, UWB devices, WiFi, and WiMAX devices, among others.

In one implementation, a Bluetooth device discovery can be done by having one device initiating queries that are broadcast or unicast addressed. Service discovery is the process whereby services available on endpoints at the receiving device are discovered by external devices. Service means the interfaces described by means of Device Descriptors set. Service discovery can be accomplished by issuing a query for each endpoint on a given device, by using a match service feature (either broadcast or unicast) or by having devices announce themselves when they join the network. Service discovery utilizes the complex, user, node or power descriptors plus the simple descriptor further addressed by the endpoint (for the connected application object). The service discovery process enables devices to be interfaced and interoperable within the network. Through specific requests for descriptors on specified nodes, broadcast requests for service matching and the ability to ask a device which endpoints support application objects, a range of options are available for commissioning universal healthcare applications that interact with each other and are compatible.

FIG. 1C shows a logical interface between two connected systems, a Manager (typically a host/BCC) and an Agent (typically a device/DCC). The interface is generally patterned after the International Organization for Standardization's Open Systems Interconnection (OSI-ISO) seven-layer communications model. That model was created to foster interoperability between communicating systems by isolating functional layers and defining their abstract capabilities and the services relating adjacent levels. The four so-called “lower” OSI layers are the (1) physical, (2) data link, (3) network, and (4) transport layers. Layers 5, 6, and 7—the session, presentation, and application layers—are known as “upper” layers. Layers 1-4, the “lower” layers, constitute the transport system, which provides reliable transport of data across different media. The session layer includes services for connection and data transfer (e.g., session connect, session accept, and session data transfer). The Presentation Layer holds services for negotiating abstract syntax, such as Medical Device Data Language (MDDL) over CMDISE ASN., and transfer syntax, which are basic encoding rules (BER) or optimized medical device encoding rules (MDER). MDERs are abstract message definitions that include primitive data types such as FLOAT (floating-point numeric) or 32-bit integer, and the way they are encoded as bits and bytes for communication over the transport. The association control service element or ACSE (ISO/IEC 8650) provides services used initially to establish an association between two communicating entities, including association request and response, association release, association abort, and others. The ROSE or remote operation service element (ISO/IEC 9072-2) provides basic services for performing operations across a connection, including remote operation invoke, result, error, and reject. The CMDISE or common medical device information service element, is based on CMIP (the common management information protocol; ISO/IEC 9596-1) and provides basic services for managed objects, including the performance of GET, SET, CREATE, DELETE, ACTION, and EVENT REPORT functions. These services, invoked using ROSE primitives, represent the basic means for interacting with the medical data information base (MDIB). The medical data information base supplies an abstract object-oriented data model representing the information and services provided by the medical device. The data originate in the device agent (the right side in FIG. 1) and are replicated during connection on the Manager side of the system. Objects include the medical device system (MDS), virtual medical device (VMD), channels, numerics, real-time sample arrays, alerts, and others. Application Processes. This layer represents the core software on both the host (BCC) and device (DCC) sides of the connection that either creates or consumes the information that is sent across the link.

To provide orderly system behavior, a finite-state-machine model for the life cycle of a BCC-DCC interaction is used. After a connection is made at the transport level, the DCC proceeds to associate with the managing BCC system and configure the link. Once configuration has been completed, the communication enters the normal operating state in which, in accordance with the profile that is active, data may be exchanged between the two systems. If the device is reconfigured—for example, if a new plug-in module is added—it can transition through the reconfiguration state, in which the Manager is notified of the changes in the Agent's MDIB data model, and then cycle back to the operating state. The interactions between an Agent (DCC) system and a Manager (BCC) system begins once the Manager transport layer indicates that a connection has been made, the Manager application, using ACSE PDUs, initiates the association-establishment process, which results on the Agent side in the association-request event being generated. Association being accomplished, the Agent notifies the Manager that the MDS object has been created. This MDS-create-notification event report includes static information about the device's manufacturer, its serial number, and other configuration data. At this point, the Manager can create a context scanner within the device's MDIB. A scanner is a tool that collects information of various kinds from the device's MDIB and sends it to the Manager in event-report messages. A periodic scanner will examine a set list of data items in the MDIB (for example, in an infusion pump, this list might include the parameters “volume infused” and “volume to be infused”), and send an update at regular intervals of every few seconds.

In one example with an infusion-pump, a context scanner is used to report the object-model containment tree to the Manager system. This way, the Manager can “discover” the data that are supported by a given device. Because the MDIB contains a finite set of object types (MDS, VMD, channel, numeric, alert, battery, etc.), a Manager does not need to know what an infusion device looks like, it can simply process the containment tree retrieved from the context scanner and configure itself accordingly.

Once the containment tree has been sent to the Manager system and the Agent has received a confirmation reply, the MDS object indicates that it has entered the configured state and automatically passes to the operating state, ready to begin regular data communications. A set of base station-to-device interfaces are provided and include those that enable appliances, medical instruments, patient record cards, and user interface components, among others, to be added to and removed from the station in a plug-and-play fashion.

The above system forms an interoperable health-care system with a network; a first medical appliance to capture a first vital information and coupled to the network, the first medical appliance transmitting the first vital information conforming to an interoperable format; and a second medical appliance to capture a second vital information and coupled to the network, the second medical appliance converting the first vital information in accordance with the interoperable format and processing the first and second vital information, the second medical appliance providing an output conforming to the interoperable format.

The appliances can communicate data conforming to the interoperable format over one of: cellular protocol, ZigBee protocol, Bluetooth protocol, WiFi protocol, WiMAX protocol, USB protocol, ultrawideband protocol. The appliances can communicate over two or more protocols. The first medical appliance can transmit the first vital information over a first protocol (such as Bluetooth protocol) to a computer, wherein the computer transmits the first vital information to the second medical appliance over a second protocol (such as ZigBee protocol). The computer can then transmit to a hospital or physician office using broadband such as WiMAX protocol or cellular protocol. The computer can perform the interoperable format conversion for the appliances or devices, or alternatively each appliance or device can perform the format conversion. Regardless of which device performs the protocol conversion and format conversion, the user does not need to know about the underlying format or protocol in order to use the appliances. The user only needs to plug an appliance into the network, the data transfer is done automatically so that the electronic “plumbing” is not apparent to the user. In this way, the user is shielded from the complexity supporting interoperability.

Another exemplary process for monitoring a patient is discussed next. The process starts with patient registration (1000) and collection of information on patient (1002). Next, the process selects a treatment template based on treatment plan for similar patients (1004). The process generates a treatment plan from the template and customizes the treatment plan (1006). The system considers the following factors: medical condition, amount of weight to lose, physician observations regarding mental state of the patient.

In the event the patient has extensive or contraindicating medical history or information, the system alerts the doctor to manually review the patient file and only generate recommendations with authorization from a doctor.

The doctor subsequently reviews and discusses the customized plan with the patient. In one embodiment, during the discussion, the doctor offers the patient the opportunity to enroll in the automated monitoring program. For a monthly or yearly fee, the system would provide the patient with periodic encouragements or comments from the system or the physician. In one embodiment, the doctor can provide the patient with an optional monitoring hardware that measures patient activity (such as accelerometers) and/or vital signs (such as EKG amplifiers).

Upon user enrollment, the system's workflow helps the doctor with setting goals with the patient, establishing a bond of trust and loyalty, and providing positive feedback for improving compliance. Loyalty to the practitioner initially produces higher compliance, emphasizing that establishing a close relationship helps. By providing rapid feedback through instant messaging or emails, the system helps doctors earn the patient's respect and trust, set goals together with the patient, and praise progress when it occurs.

Once enrolled, the system collects data on patient compliance with a treatment plan (1008). This can be done using mobile devices with sensors such as MEMS devices including accelerometer and others as described more fully below. Alternatively, the system periodically requests patient data will be weighed, measured, body fat calculated, blood pressure, resting heart rate and overall well-being. In one embodiment, the system provides a daily (7 days a week) counseling process using texting, email or social network communications.

The process also accumulates reward points for patient to encourage healthy activities, such as jogging, walking, or gardening (1010). The process also compares patient progress with other patients (1012) and sends automatic encouraging messages to patients (1014). Upon patient authorization, the system announces the patient's goals and progress to a social network such as Facebook. The social network strengthens the patient's will for dieting and exercise by the “extent to which individuals perceive that significant others encourage choice and participation in decision-making, provide a meaningful rationale, minimize pressure, and acknowledge the individual's feelings and perspectives.” The system supplements the treatment through social supports at home and encourages the patient to make their family and close friends aware of their condition and the expectations of diet and exercise. This will provide the patient with encouragement and accountability.

Periodically, the system shows patient status to doctor (1016) and presents recommendations to doctor on preventive steps, such as check-ups and basic blood tests (1018). Automatically, the system schedules in person consultation for patient and doctor (1020). Captured progress data can be viewed by the physicians and patients using a web based system. The physician can review all interactions between the system and the patient. The physician is able to see their progress reports, interactive e mail which includes daily menus and notes between the service and the patient. The physician will be able to check on the patient's progress at any time of day or night. The system improves the Doctor-Patient relationship and influences compliance.

The system's interactive behavior combines four key elements: just-in-time information, automation in checking with patients, persuasive techniques or messaging, and user control elements. In one embodiment, reports about the user's calorie consumption and exercise activity over time, and in comparison to similarly situated people, are generated.

The system provides meaningful feedback, allowing customers to “see” their food consumption, exercise and the impact of changes. When calories from eating go up between months, a graph depicts so and by how much. Without the system's report to conveniently compare food consumption and exercise from one week to the next, it would be much harder to track those changes. Feedback provides the information crucial to bring about self-awareness of one's actions.

Additionally, the greater value of the system is that it provides useful information about what other similar users' actions and impacts are like. The report shows where the patient's energy intake and outtake are in comparison to the healthiest and the average person. This information serves as a descriptive norm, letting customers know where they are in the spectrum of average and healthy people. When customers see that they are below or even just above average, they want to move “up” on the exercise but reduce their calorie intake. As humans, users are programmed to want to be unique . . . but not too unique—they want to have “normal” food consumption and normal health.

With regard to the message persuasiveness, content is positive and targeted to the user's specific situation. The system provides action opportunities with its reports. If the user is mildly overweight, it might offer a suggestion of having salad with a low calorie dressing for dinner One embodiment provides a “marketplace” concept, which means that the suggestion would be accompanied by, say, a coupon for salad at a local restaurant. In one embodiment, the system has prior relationships with partners such as restaurants that would offer meals with preset calorie and can send the user coupons to different partners on different days, thus providing users with a wide range of healthy food selections. The system's power lies in its ability to simultaneously prep individuals for action and give them an easy opportunity to do so.

In sum, the system's feedback is effective because:
It is provided frequently, as soon after the consumption behavior as possible.
It is clearly and simply presented.
It is customized to the patient's specific medical condition.
It is provided relative to a meaningful standard of comparison.
It is provided over an extended period of time.
It includes specific food consumption and calorie breakdown.
It is interactive through instant messaging, email, or social networks.

In one embodiment, body analysis data is determined from enrollment data, and include: body mass ratio, pounds of lean muscle mass, percentage of body fat and an optimal range for the specific individual of that percentage, pounds of body fat and an optimal range of body fat for that specific individual, and suggested pounds of body fat to lose. The body analysis includes the following: Basal Metabolic Rate (BMR) is the number of calories burned by the patient's lean body mass in a 24 hour period at complete rest using formulas such as the Harris-Benedict formula or other suitable formulas. Specific Dynamic Action of Foods (SDA) is the numbers of calories required to process and utilize consumed foods (in one case estimated at 5-15% of BMR, depending on personalization). Resting Energy Expenditure (REE) is the sum of BMR and SDA and represents the number of calories that the patient's body requires in a 24 hour period at complete rest. The system determines a Program Recommendation Total Caloric Intake as the caloric supplement required to achieve weight loss of approximately 2 pounds per week. Medications or stimulating substances (such as caffeine, gingsen, or diethylpropion) to assist in weight loss may be recommended and if so the program increases calorie consumption based on a model of the patient's response to such substances.

In one embodiment using the optional mobile monitoring hardware, the system determines Activities of Daily Living (ADL) as the number of calories burned by the patient's body during normal daily activities using accelerometers. The accelerometers can also determine the Calories Burned by Exercise as the number of calories burned by the exercises selected by the patient. Also included, is the level and intensity of the patient's activities. In one embodiment without the optional mobile monitoring hardware, the system approximates the Activities of Daily Living (ADL) as an average of calories expected to be burned by the patient's body during normal daily activities, and in one case is estimated at 20% or REE. The system can also receive averaged approximations of Calories Burned by Exercise is the number of calories burned by the exercises selected by the patient. Also included, is the level and intensity of the patient's activities.

An exemplary process for monitoring patient food intake is discussed next. The process first determines and recommends optimal diet based on patient parameters (1030). To monitor progress, the process takes user entered calorie data and optionally captures images of meals using a mobile device such as a mobile camera (1032). The process then translates images of the meals into calories (1034). The patient's actual diet is then compared to with the recommended diet (1036).

In one embodiment, the camera captures images of the food being served to the patient. The image is provided to an image search system such as the Google image search engine, among others. The search returns the likely type of food in the dish, and an estimation of the container volume is done. In one embodiment, the volume can be done using a 3D reconstruction using two or more images of the food found as the intersection of the two projection rays (triangulation). The two images from the 2D images are selected to form a stereo pair and from dense sets of points, correspondences between the two views of a scene of the two images are found to generate a 3D reconstruction is done to estimate the 3D volume of each food item.

The system determines and looks up a database that contains calorie per unit volume for the dish being served, and multiplies the food volume estimate with the calorie per unit volume for the type of food to arrive at the estimated total calorie for the dish. The user is presented with the estimate and the details of how the estimation was arrived at are shown so the user can correct the calorie estimation if needed.

Next is an exemplary exercise recommendation and monitoring process. First, the process determines and recommends an exercise routine that is customized to the patient's medical condition (1040). The process then captures patient exercise activity using micro-electromechanical systems (MEMS) sensors (1042). The MEMS sensors can include Accelerometer, Gyroscope, Magnetometer, Pressure sensor, Temperature, and Humidity sensor, among others. The process then correlates actual patient activity with the recommended exercises (1044).

An exemplary process for applying the power of social networking to health is discussed next. The process collects data from crowd (1050). The process then compares the performance of the patient with similar patients (1052). The process engages and motivates through Social Network Encouragement (1054).

The system or method described herein may be deployed in part or in whole through a machine that executes software programs on a server such as server, domain server, Internet server, intranet server, and other variants such as secondary server, host server, distributed server, or other such computer or networking hardware on a processor. The processor may be a part of a server, client, network infrastructure, mobile computing platform, stationary computing platform, or other computing platform. The processor may be any kind of computational or processing device capable of executing program instructions, codes, binary instructions or the like that may directly or indirectly facilitate execution of program code or program instructions stored thereon. In addition, other devices required for execution of methods as described in this application may be considered as a part of the infrastructure associated with the server.

The system or method described herein may be deployed in part or in whole through network infrastructures. The network infrastructure may include elements such as computing devices, servers, routers, hubs, firewalls, clients, wireless communication devices, personal computers, communication devices, routing devices, and other active and passive devices, modules or components as known in the art. The computing or non-computing device(s) associated with the network infrastructure may include, apart from other components, a storage medium such as flash memory, buffer, stack, RAM, ROM, or the like. The processes, methods, program codes, and instructions described herein and elsewhere may be executed by the one or more network infrastructural elements.

The elements described and depicted herein, including flow charts, sequence diagrams, and other diagrams throughout the figures, imply logical boundaries between the elements. However, according to software or hardware engineering practices, the depicted elements and the functions thereof may be implemented on machines through the computer executable media having a processor capable of executing program instructions stored thereon and all such implementations may be within the scope of this document. Thus, while the foregoing drawings and descriptions set forth functional aspects of the disclosed methods, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this document. As such, the depiction or description of an order for various steps should not be understood to require a particular order of execution for those steps, unless required by a particular application, or explicitly stated or otherwise clear from the context.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device, or other hardware. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A remote health system, comprising:
a data transceiver to communicate data to a remote computer over a network; a screen and a camera for video conferencing with a patient;
one or more medical sensors to sense patient condition coupled to the data transceiver;
an analyzer coupled to the remote computer to make treatment recommendations by comparing medical indications from a large population to patient condition based on medical sensor outputs; and
a treatment recommender coupled to the analyzer to provide a proposed treatment to a doctor.

2. The system of claim 1, wherein the screen and camera provide tele-health consultations between a doctor and the patient.

3. The system of claim 1, wherein the screen displays an image of the doctors and the patient using the camera.

4. The system of claim 1, wherein the remote computer allow substantially real-time interaction between the doctors and the patient.

5. The system of claim 1, wherein the analyzer generates analytics data for the medication indications associated with the large population.

6. The system of claim 5, wherein analytics data comprises data related to at least one of heart disease patterns, cancer patterns, chronic lower respiratory diseases, cardiac diseases, alzheimer's disease, diabetes, obesity, influenza and pneumonia, nephritis, nephrotic syndrome, and nephrosis.

7. The system of claim 5, wherein the analytics data is related to the large population suffering from substantially similar type of diseases.

8. A method for providing treatment recommendations, the method comprising:
communicating data to a remote computer over a network;
performing video conferencing with a patient;
sensing patient condition associated with the patient;
making treatment recommendations by comparing medical indications from a large population to patient condition based on sensed data; and
providing a proposed treatment to a doctor.

9. The method of claim 8, wherein the method further comprises providing tele-health consultations between a doctor and the patient.

10. The method of claim 8, wherein the method further comprises displaying an image of the doctors and the patient.

11. The method of claim 8, wherein the method further comprises allowing substantially real-time interaction between the doctors and the patient.

12. The method of claim 8, wherein the method further comprises generating analytics data for the medication indications associated with the large population.

13. The method of claim 12, wherein analytics data comprises data related to at least one of heart disease patterns, cancer patterns, chronic lower respiratory diseases, cardiac diseases, alzheimer's disease, diabetes, obesity, influenza and pneumonia, nephritis, nephrotic syndrome, and nephrosis.

14. The method of claim 12, wherein the analytics data is related to the large population suffering from substantially similar type of diseases.

15. A method to provide automatic messaging to a client on behalf of a healthcare treatment professional, comprising:
setting up one or more computer implemented agents with rules to respond to a client condition, wherein each agent communicates with another computer implemented agent, the client or the treatment professional;
during run-time, receiving a communication from the client and in response selecting one or more computer implemented agents to respond to the communication; and
automatically formatting a response to be rendered on a client mobile device to encourage healthy behavior.

16. The method of claim 15, comprising
collecting information on client;
selecting a treatment template based on treatment plan for similarly situated people;
generating treatment plan from the treatment template and customizing the treatment plan; and
obtaining approval from the treatment professional.

17. The method of claim 15, comprising automatically collecting calorie intake of an item to be consumed with a processor controlled camera and calorie detection code.

18. The method of claim 17, comprising automatically identifying volume and content of the item.

19. The method of claim 17, comprising automatically determining if the item is in a recommended nutritional guideline and sending messages suggesting alternatives that replace or supplement the item to at least meet the nutritional guideline.

20. The method of claim 17, comprising
automatically collecting data on treatment plan compliance using at least one Micro-Electro-Mechanical System (MEMS) device;
modeling patient movements; and
converting the patient movements into energy consumption.
